(19) United States
(12) Patent Application Publication
(10) Pub. No.: US 2026/0008967 A1
(43) Pub. Date: Jan. 8, 2026

(54) PROCESSES FOR PRODUCING LIGHT OLEFINS AND AROMATICS

(71) Applicant: SABIC GLOBAL TECHNOLOGIES B.V., BERGEN OP ZOOM (NL)

(72) Inventors: Vidya Sagar GUGGILLA, Bangalore (IN); Rajitha VUPPULA, Bangalore (IN); Ahmed Suliman AL-ZENAIDI, Riyadh (SA)

(73) Assignee: SABIC GLOBAL TECHNOLOGIES B.V., BERGEN OP ZOOM (NL)

(21) Appl. No.: 19/125,250

(22) PCT Filed: Nov. 9, 2023
(86) PCT No.: PCT/IB2023/061321

§ 371 Date: Apr. 28, 2025

(30) Foreign Application Priority Data
Nov. 9, 2022 (EP) 22206480.0

(51) Int. Cl. C10G 69/02; B01J 8/02; B01J 8/18

(52) U.S. Cl. CPC C10G 69/02; B01J 8/0278; B01J 8/1827; C10G 2300/1003; C10G 2400/20; C10G 2400/30

(57) ABSTRACT

Processes and systems to produce light olefins and aromatics are described. A process can include hydrotreating a hydrocarbon that includes tight oil, mixed waste plastic oil, or a blend thereof to produce a hydrotreated hydrocarbon feed. The hydrotreated hydrocarbon feed can be separated into at least two fractions having boiling temperatures above 300° C. and less than 300° C. Both fractions can be further processed to produce light olefins and aromatics.

### CROSS REFERENCE TO RELATED APPLICATIONS

The present application claims the benefit of priority to European Patent Application No. 22206480.0, filed Nov. 9, 2022, the entire contents of which are incorporated herein by reference in their entirety.

### BACKGROUND OF THE INVENTION

### A. Technical Field

The invention generally concerns processes and systems that can produce light olefins and aromatics. A process can include hydrotreating a hydrocarbon that includes tight oil, mixed waste plastic oil, or a blend thereof, to produce a hydrotreated hydrocarbon feed. The hydrotreated hydrocarbon feed can be separated into at least two fractions having boiling temperatures above 300° C. and less than 300° C. Both fractions can be further processed to produce light olefins and aromatics.

### B. Background Art

Light olefins (C₂ to C₄ olefins) and single ring aromatics including benzene, toluene, and xylene are chemicals commonly used for producing plastics and other polymers. For example, light olefins are used to produce polyethylene, polypropylene, ethylene oxide, ethylene chloride, propylene oxide, and acrylic acid, which, in turn, are used in a wide variety of industries such as the plastic processing, construction, textile, and automotive industries. Benzene is a precursor for producing polystyrene, phenolic resins, polycarbonate, and nylon. Toluene is used for producing polyurethane and as a gasoline component. Xylene is feedstock for producing polyester fibers and phthalic anhydride.

Conventionally, olefins are produced by steam cracking and/or paraffin dehydrogenation. BTX is typically produced by catalytic reforming of naphtha in addition to steam cracking of liquid feed. The feedstock for light olefin production can include natural gas, petroleum liquids, and carbonaceous materials including coal, recycled plastics or any organic material. For example, U.S. Pat. No. 9,328,299 to Funk et al. describes controlling the make-up of feed streams that include heavier hydrocarbons to produce light olefins by optimizing cracking, reforming, and/or multiple separation units such as extraction and/or adsorption units to separate C₅ to C₁₁ hydrocarbons.

Overall, while systems and processes to produce light olefins and aromatics exist, the need for improvements in this field persists.

### SUMMARY OF THE INVENTION

A discovery has been made that provides a solution at least one of the problems associated with the systems and processes to produce light olefins. In one aspect, the invention can use a hydrocarbon feed stream that includes low value feedstock such as tight oil, mixed waste plastic oil, or a blend thereof, to produce a hydrotreated hydrocarbon feed to produce light olefins and aromatics. The invention provides the advantage of upgrading the low value feedstock to high value streams with minimum additional equipment, which, in turn, gives high amount of chemicals compared to use of feedstocks in the existing refinery process. The invention provides a simple, cost effective process for producing light olefins and aromatics from a low value feedstock. Light olefins can include ethane, propane, or butane, or any combination thereof. Aromatics can include benzene, toluene, xylene, or any combination thereof.

In one aspect of the present invention, processes to produce light olefins and aromatics are described. A process can include a step (a) of hydrotreating a hydrocarbon feed comprising tight oil, mixed waste plastic oil, or a blend thereof, to produce a hydrotreated hydrocarbon feed. In some aspects, the hydrocarbon feed also includes naphtha. Hydrotreating reaction conditions can include a temperature of 300° C. to 600° C., preferably 310 to 420° C., a pressure of 2 MPa to 15 MPa preferably 4 MPa to 12 MPa, or a combination thereof. In some embodiments, the process can include treating the hydrocarbon feed prior to step (a) hydrotreating under conditions sufficient to remove one or more metals, preferably barium (Ba), calcium (Ca), magnesium (Mg), nickel (Ni), potassium (K), sodium (Na), vanadium (V), silicon (Si), arsenic (As), or any combination thereof.

Step (b) can include separating the hydrotreated hydrocarbon feed of step (a) into a first fraction having a boiling temperature of less than 300° C. and a second fraction having a boiling temperature of 300° C. or more. The first fraction can be converted into light olefins and aromatics, and/or the second fraction can be converted into aromatics.

Converting the second fraction into aromatics can include catalytically reforming the second fraction under conditions sufficient to produce aromatics and a light intermediate hydrocarbon stream. Catalytic reforming conditions can include a temperature of 400 to 600° C., preferably 450 to 520° C., a reaction pressure of 0.5 MPa to 5 MPa, preferably 1 MPa to 3.5 MPa, or a combination thereof.

The first fraction, the light intermediate hydrocarbon stream, or a blend thereof, can be converted into light olefins and aromatics by catalytically cracking the first fraction under conditions sufficient to produce a products stream that can include aromatics and a gaseous C5− hydrocarbon stream. In some embodiments, naphtha can be blended with the first fraction and/or intermediate hydrocarbon stream. Catalytic cracking conditions can include a temperature of 500 to 750° C., preferably specifically 600 to 675° C., a pressure of 0.1 to 0.5 MPa, preferably 0.15 MPa to 0.3 MPa, or any combination thereof.

The process can further include steam cracking the gaseous C5− (e.g. C5, C4, C3,C2, and the like) hydrocarbon stream under conditions sufficient to produce light olefins. Steam cracking conditions can include a temperature of 700 to 1000° C., preferably 800 to 950° C., a pressure of 0.01 MPa to 0.2 MPa, preferably 0.025 MPa to 0.1 MPa, or any combination thereof.

Separating the hydrotreated hydrocarbon feed of step (a) can produce a third fraction having a boiling temperature less than 30° C. The third fraction can be steam cracked under conditions sufficient to produce light olefins. The third fraction can be combined with the gaseous C₁ to C₅ hydrocarbon stream prior to steam cracking.

In some aspects, converting the second fraction into aromatics can produce a C9+ or a heavy fuel oil fraction. Such a fraction can be hydrotreated or catalytically cracked based on the paraffin content of the fraction. In some instances, the fraction is used to supply heat to the catalytic cracker.

Systems to produce light olefins and aromatics are also described. A system to run the processes of the present invention can include a hydrotreater capable of hydrotreating a hydrocarbon feed that includes tight oil, mixed plastic oil, or a blend thereof, to produce a hydrotreated hydrocarbon feed. A separator can be coupled to the hydrotreater. The separator can be capable of separating the hydrotreated hydrocarbon feed into a first fraction having a boiling temperature of less than 300° C. and a second fraction having a boiling temperature of greater than 300° C. A catalytic reformer can be coupled to the separator. The catalytic reformer can be capable of reforming the second fraction into aromatics. A catalytic cracker can be coupled to the catalytic reformer. The catalytic cracker can be capable of catalytically cracking the first fraction into aromatics and a gaseous hydrocarbon feed that includes C5− hydrocarbons. A steam cracker can be coupled to the catalytic cracker. The steam cracker can be capable of steam cracking the gaseous hydrocarbon feed to produce light olefins.

Other embodiments of the invention are discussed throughout this application. Any embodiment discussed with respect to one aspect of the invention applies to other aspects of the invention as well and vice versa. Each embodiment described herein is understood to be embodiments of the invention that are applicable to other aspects of the invention. It is contemplated that any embodiment or aspect discussed herein can be combined with other embodiments or aspects discussed herein and/or implemented with respect to any method or composition of the invention, and vice versa. Furthermore, compositions of the invention can be used to achieve methods of the invention.

The following includes definitions of various terms and phrases used throughout this specification.

The term “tight oil” refers to the petroleum extracted from low permeability rock that can use stimulation using hydraulic fracturing to create sufficient permeability to help or allow the mature oil to flow. Tight Oil has an API gravity between 20° to 55° as measured by the ASTM D287 standard. Non-limiting examples of sources of tight oil can include Bakken reservoir and Eagle Ford reservoir in the United States.

The term “mixed waste plastic oil” refers to liquid that is derived from the conversion of mixed plastic waste. For example, oil derived from heating mixed plastics that include plastic films and multilayer packaging in an oxygen-free atmosphere to produce a liquid. Mixed waste plastic oil can have an API gravity of 40° to 60° as measured by the ASTM D287 standard and a boiling range of 80° C. to 600° C.

The term “fuels” refers to products used as energy carrier. Fuels typically are mixtures of different hydrocarbon compounds. Non-limiting examples of fuels include gasoline, jet fuel, diesel fuel, heavy fuel oil, and petroleum coke.

The terms “aromatic hydrocarbons” or “aromatics” refer to cyclically conjugated hydrocarbon with a stability (due to delocalization conjugated pi system) that is greater than that of a hypothetical localized structure (e.g., a Kekulé structure). Non-limiting examples of aromatics include benzene, toluene, and xylene. The term “BTX” refers to a mixture of benzene, toluene, and xylenes.

The term “olefin” refers to an unsaturated hydrocarbon compound containing at least one carbon-carbon double bond. “Olefins” can include a mixture that can include two or more olefins (e.g., ethylene, propylene, butadiene, butylene-1, isobutylene, isoprene, and cyclopentadiene). The term “light olefins” refers to ethylene, propylene, butylene, or a mixture thereof. The term “higher olefins” refers to olefins having 5 carbons or more.

The term “LPG” refers to “liquefied petroleum gas”. LPG generally includes of a blend of C2-C4 hydrocarbons, i.e., a mixture of C2, C3, and C4 hydrocarbons.

The term “C#hydrocarbons” refers to hydrocarbon molecules having # or more carbon atoms, where “#” is a positive integer. For example. the term “C5+ hydrocarbons” is meant to describe a mixture of hydrocarbons having 5 or more carbon atoms. The term “C5+ alkanes” accordingly relates to alkanes having 5 or more carbon atoms. The term “C5− alkanes” accordingly relates to alkanes having 5 or less carbon atoms.

The term “naphtha” refers to a hydrocarbon composition having a boiling range between 35° C. to about 200° C. Naphtha can include paraffins, cyclic paraffins (naphthenes), and aromatic hydrocarbons.

The term “paraffin” or “alkane” refers to saturated hydrocarbons with the general formula of CₙH₂ₙ₊₂. Non-limiting examples of paraffins/alkanes include ethane, propane, butane, pentanes, hexane, heptane, etc.

The phrase “Column X” where X is an integer refers to a Column in the Periodic Table.

The terms “about” or “approximately” are defined as being close to as understood by one of ordinary skill in the art. In one non-limiting embodiment, the terms are defined to be within 10%, preferably within 5%, more preferably within 1%, and most preferably within 0.5%.

The terms “wt. %”, “vol. %”, or “mol. %” refers to a weight percentage of a component, a volume percentage of a component, or molar percentage of a component, respectively, based on the total weight, the total volume of material, or total moles, that includes the component. In a non-limiting example, 10 grams of component in 100 grams of the material is 10 wt. % of component.

The term “bulk metal oxide catalyst” as that term is used in the specification and/or claims, means that the catalyst includes one metal, and does not have to have a carrier or a support.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising,” “including,” “containing,” or “having” in the claims, or the specification, may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The systems and processes of the present invention can “comprise,” “consist essentially of,” or “consist of” particular ingredients, components, compositions, etc. disclosed throughout the specification. With respect to the transitional phrase “consisting essentially of,” in one non-limiting aspect, a basic and novel characteristic of the systems and processes of the present invention are their abilities to produce olefins and aromatics from a hydrocarbon feed that includes tight oil, waste plastic oil, or a combination thereof.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings.

FIG. 1 is an illustration of a system and process of the present invention that includes a hydrotreater, a separation unit, a catalytically reforming unit, a catalytic cracking unit, and a steam cracking unit.

FIG. 2 is an illustration of another system and process of the present invention that includes the system of FIG. 1 with the addition of a feed pretreatment unit positioned upstream of the hydrotreater.

FIG. 3 is an illustration of another process of the present invention using the systems of FIG. 1 and FIG. 2 that can produce a fraction having a boiling temperature of less than 30° C.

While the invention is susceptible to various modifications and alternative forms, specific embodiments thereof are shown by way of example in the drawings. The drawings may not be to scale.

### DETAILED DESCRIPTION OF THE INVENTION

A discovery has been made that provides a solution to at least one of the problems associated with the systems and processes for producing olefins and aromatics from tight oil. waste plastic oil, or a mixture thereof. In one aspect, the invention can include a process for upgrading low value feedstock (e.g., tight oil and/or mixed plastic oil) to high value streams with minimal change (and lower capital expenditure) to conventional refining processing. This provides the advantage of producing an increased amount of olefins and aromatics as compared to conventional feedstock in a refining process.

These and other non-limiting aspects of the present invention are discussed in further detail in the following sections with reference to the Figures.

### A. Systems and Methods to Produce Light Olefins and Aromatics

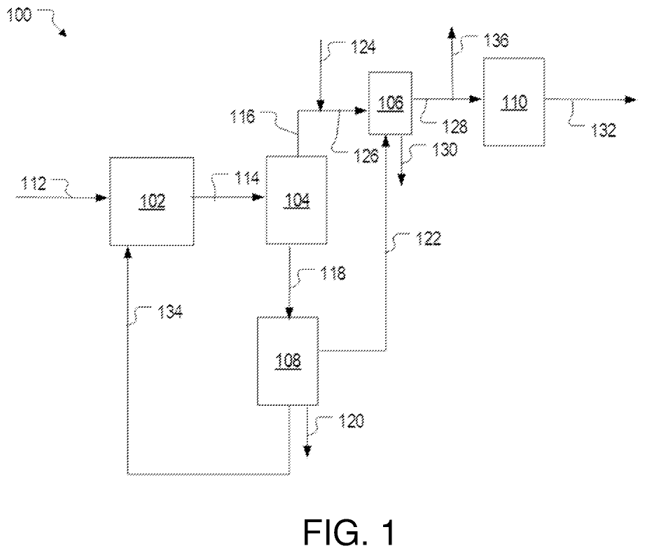

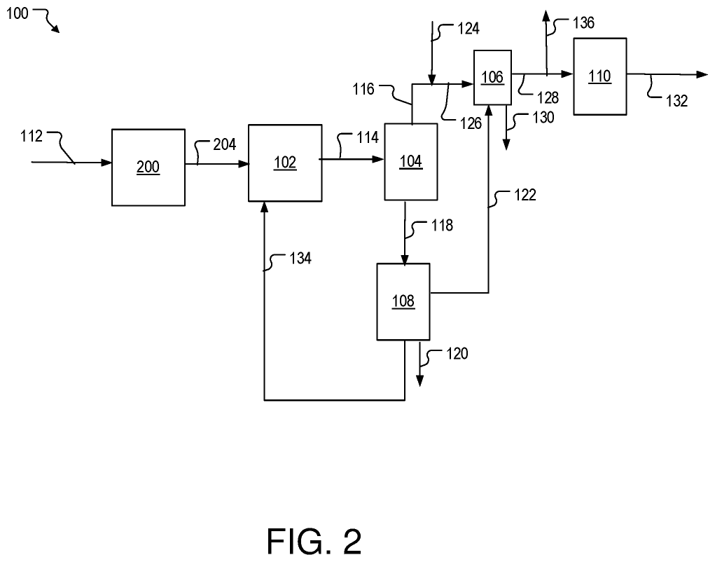

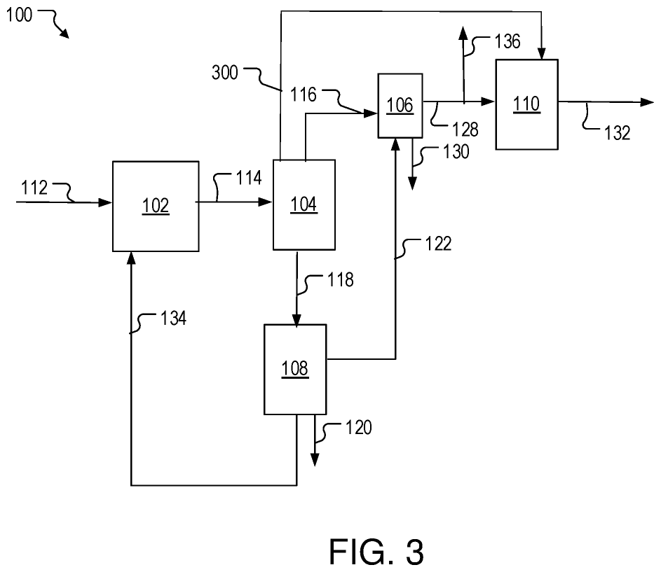

Referring to FIGS. 1-3, systems and processes to produce light olefins and aromatics are described. FIG. 1 is an illustration of a system and process of the present invention that includes a hydrotreater, a separation unit, a catalytically reforming unit, a catalytic cracking unit, and a steam cracking unit. FIG. 2 includes the system of FIG. 1 with the addition of a feed pretreatment unit positioned upstream of the hydrotreater. FIG. 3 depicts a process using the systems of FIG. 1 and FIG. 2 that can produce a fraction having a boiling temperature of less than 30° C. System 100 can include hydrotreater 102, separation unit 104, catalytically cracking unit 106, catalytic reforming unit 108, and steam cracking unit 110. In system 100, hydrocarbon feed 112 that includes tight oil, mixed waste plastic oil, or a mixture thereof (“hydrocarbon feed”), can enter hydrotreating unit 102. Hydrocarbon feed 112 has C1+ hydrocarbons. In some aspects, if gaseous hydrocarbons are formed, they are not separated from hydrocarbon feed 112 in the hydrotreating unit 102. Hydrotreating unit 102 can include one or more reactors in any configuration. In hydrotreating unit 102, hydrocarbon feed 112 can be contacted with hydrogen, in the presence of a hydrotreating catalyst composition, to produce a hydrotreated hydrocarbon feed 114. Hydrotreated hydrocarbon feed 114 can have a reduced nitrogen content ranging from about 0.1 to about 30 ppm and a reduced sulfur content ranging from 10 to 200 ppm. The hydrotreating catalyst system composition can include a combination of suitable catalysts for the reduction and/or removal of nitrogen, sulfur, and/or higher olefins among other contaminants, from hydrocarbon feed 112. The hydrotreating catalyst composition can be configured in any suitable configuration within a reactor in hydrotreating unit 102. The hydrotreating catalyst can include any conventional hydrotreating catalyst (e.g., bulk metal catalyst or a supported catalytic metal catalyst). For example, the hydrotreating catalyst can include support material loaded with catalytically active metal compounds. In some aspects, the hydrotreating catalyst can include an amine compound and a non-amine containing polar additive. The support material of the hydrotreating catalyst can include suitable inorganic oxide material typically used to carry catalytically active metal components. Non-limiting examples of inorganic oxide materials include alumina, silica, silica-alumina, magnesia, zirconia, boria, titania and mixtures of any two or more of such inorganic oxides. Non-limiting examples of catalytically active metal compounds are selected from Column 6 metals (e.g., chromium (Cr), molybdenum (Mo), and tungsten (W)) and Columns 9 and 10 of the Periodic Table metals (e.g., cobalt (Co) and nickel (Ni)). Phosphorous (P) can also be a component. The weight percentage of the catalytically active metal compound incorporated into the support material depends upon the application. Non-limiting examples of amine compounds include ether amine compounds, alkyl or alkenyl amine compounds, or amine oxide compounds. The hydrotreating conditions in hydrotreating unit 102 can depend on the desired level of conversion, the type of catalysts implemented, and the level of contaminants in hydrocarbon feed 112. Suitable reaction temperatures can range from 400 to 600° C., or any range or value there between for example 300° C., 325° C., 350° C., 375° C., 400° C., 425° C., 450° C., 475° C., 500° C., 525° C., 550° C., 575° C., 600° C. or 310 to 420° C. Suitable reaction pressures can be from 2 MPa to 15 MPa or any range or value there between, for example 2 MPa, 3 MPa, 4 MPa, 5 MPa, 6 MPa, 7 MPa, 8 MPa, 9 MPa, 10 MPa, 11 MPa, 12 MPa, 13 MPa, 14 MPa, or 15 MPa or 4 MPa to 12 MPa. Suitable liquid hourly space velocity (LHSV) can be in the range of from 0.2 to 10 hr⁻¹.

In some embodiments, hydrotreating unit 102 can include a pretreatment unit to remove metal contaminants from hydrocarbon feed 112. In some embodiments, a pretreatment unit can be positioned upstream of hydrotreating unit 102. In some embodiments, a pretreatment unit is not implemented. Referring to FIG. 2, system 100 can include pretreatment unit 202 positioned upstream of hydrotreating unit 102. Pretreatment unit 202 can be any known unit capable of reducing metals and/or compounds that can deactivate the hydrotreating catalysts and/or other subsequent catalysts used during the remaining process steps. Hydrocarbon feed 112 can enter pretreatment unit 202. In pretreatment unit, metal contaminants can be removed from hydrocarbon feed 112 to produce pretreated hydrocarbon feed 204. Non-limiting examples of metal contaminants Column 1 and Column 2 metals (e.g., potassium (K), barium (Ba), calcium (Ca), magnesium (Mg), and the like), Column 5 metal (e.g., vanadium (V)), Column 8 and Column 10 metals (e.g., iron (Fe), nickel (Ni), and the like), Column 14 and 15 metals (e.g., silicon (Si), arsenic (As), and the like). In some embodiments, pretreatment unit 202 includes one or more absorbent beds that include an absorbent capable of removing metal contaminates Non-limiting example of absorbents include clay, silica gel, aluminum oxide, alumina silicate, molecular sieve, activated charcoal, peanut shells, and the like. In some embodiments, pretreatment unit can be a hydrodemetallization unit that allows contact of the hydrocarbon feed 112 with a hydrodemetallization catalyst in the presence of hydrogen. Non-limiting examples of hydrodemetallization catalysts include supported catalysts that include a Column 6 metal, a Column 9 metal, a Column 10 metal, or a combination thereof. Pretreated hydrocarbon feed 204 can exit pretreatment unit 202 and enter hydrotreating unit 102 and be processed as previously described in FIG. 1.

Referring back to FIG. 1, hydrotreated hydrocarbon feed 114 can exit hydrotreating unit 102 and enter separation unit 104. Separation unit can be any suitable distillation unit or vacuum tower known to those skilled in the art may be used to distill and separate the hydrotreated hydrocarbon feed into fractions, including a first fraction 116 and a second fraction 118. First fraction 116 can have a boiling temperature less than 300° C., or 50° C. to 295° C. Second fraction 118 can have a boiling temperature of 300° C. or more, or 300° C. to 600° C.

Second fraction 118 can exit separation unit 104 and enter catalytic reforming unit 108. The catalytic reforming unit can be any suitable known aromatizing unit. Reforming unit 108 can include one or more aromatizing reformers and one or more separation units. Non-limiting examples of the catalytic reforming unit 108 can include a continuous catalytic reformer (CCR), a semi-regenerative reformer, an AROMAX® (Chevron-Phillips) unit, and the like, or combinations thereof. In reforming unit 108, second fraction 118 can be contacted with a reforming catalyst to produce aromatic stream 120, and light intermediate stream 122. For example, second fraction 118 can include paraffins and naphthenes and contact with the reforming catalyst under suitable conditions can dehydrogenate naphthenes to aromatics, isomerize paraffins and naphthenes, dehydrocyclize paraffins to aromatics, and the like. The reforming catalyst can be any suitable catalyst used for hydrocarbon aromatization. The reforming catalyst can be monometallic (e.g., platinum (Pt)), bimetallic (e.g., Pt and rhenium (Re)), multi-metallic (e.g., Pt, Re, palladium (Pd), Ni, and the like,) or combinations thereof. The metals of the reforming catalyst can promote dehydrogenation and hydrogenation, as well as contribute to dehydrocyclization and isomerization. The reforming catalyst can have acid activity (e.g., halogens/silica incorporated in alumina base). The acid activity can promote isomerization, the initial step in hydrocracking, as well as participation in paraffin dehydrocyclization. Reforming conditions can include temperature and/or pressure. A reforming reaction temperature can be 400° C. to 600° C., 450° C. to 520° C. or any value or range there between (e.g., 400° C., 425° C., 450° C., 475° C., 500° C., 525° C., 550° C., 575° C., and 600° C.). A reforming reaction pressure can be 0.5 MPa to 5 MPa, 1 MPa to 3.5 MPa, or any range or value there between (e.g., 1 MPa, 1.5 MPa, 2 MPa, 2.5 MPa, 3 MPa, and 3.5 MPa). Aromatics product stream 120 can exit reforming unit 108 and be transported, stored, or further processed (e.g., into BTX products). Light intermediate stream 122 can exit reformer 108 and enter catalytic cracking unit 106 and be further processed as described herein. In some embodiments, C9+ stream 134 can be produced from catalytic reforming unit 108. In some embodiments, the C9+ stream 134 can include sufficient paraffins that it can be recycled to hydrotreating unit 102 and/or catalytic cracking unit 106 (not shown), or used as fuel for the catalytic cracking unit. Aromatic product stream 120 can be further processed, transported or sold. In some aspects, aromatic product stream 120 can be further separated into BTX products.

First fraction 116 can exit separation unit 104 and enter catalytic cracking unit 106. In some aspects, naphtha 124 can be mixed with first fraction 116 to form combined stream 126. Combined stream 126 can also include streams from other processing units, for example light intermediate stream 122 from catalytic reforming unit 108. Combined stream 126 can be prepared by mixing first fraction 116 and naphtha 124 using conventional mixing apparatus (e.g., stirred tank, in-line mixer, and the like). When light intermediate stream 122 is included in the combined stream, it can be added to the naphtha/first fraction mixture prior to, during, or after mixing. The order of addition of the streams can be done in any manner. In some embodiments, naphtha and/or intermediate light stream 122 is not combined with the first fraction. In catalytic cracker, first fraction 116 or combined stream 126 can be contacted with a catalytic cracking catalyst to produce a products stream that includes olefins and aromatics, and gaseous hydrocarbons.

Catalytic cracking unit 106 can be any known catalytic cracking unit. By way of example, a fluid catalytic cracking also known as a fluid catalytic unit (“FCCU” or “FCU”) are commonly used processes in all modern oil refineries. Non-limiting examples of suitable fluid catalytic cracking units include, those based on technology available for license from UOP and KBR Orthoflow. In catalytic cracking unit 106, first fraction 116 or combined feed stream 126 can be pre-heated feed (e.g., using a heat exchanger and then contacted with a fluidized catalyst under conditions suitable to crack the first fraction or combined stream. Cracking can take place using a zeolite-based catalyst in a short-contact time vertical or upward-sloped pipe called the “riser.” Cracking conditions can include temperature, pressure, weight hourly space velocity, residence time, or a combination thereof. The catalytic cracking temperature can range from 500° C. to 750° C., 600° C. to 675° C., or any value or range there between (e.g., 500° C., 525° C., 550° C., 575° C., 600° C., 625° C., 650° C., and 675° C.). A reaction pressure can be 0.1 MPa to 5 MPa or any range or vale there between (e.g., 0.1 MPa, 0.5 MPa, 1 MPa, 1.5 MPa, 2 MPa, 2.5 MPa, 3 MPa, 3.5 MPa, 4 MPa, 4.5 MPa, and 5 MPa). The residence time can be 1 to 10 seconds. Suitable catalytic cracking catalysts can include zeolite-based catalysts such as HZSM-5. Contact of the first fraction or combined stream with the heated catalyst can vaporize the feed and catalyze the cracking reactions that break down the first fraction or combined stream into lighter hydrocarbon (lower molecular weight) components. The catalyst-hydrocarbon mixture can flow upward through the riser, and then the mixture can be separated via cyclones to produce an effluent stream, which is substantially free of catalyst, and spent catalyst. Spent catalyst can be disengaged from the cracked hydrocarbon vapors and be sent to a catalyst regeneration unit (not shown) where it can be regenerated and returned to catalytic cracking unit 106. The effluent stream can be cooled, quenched to stop the cracking process, and separated into light intermediate stream 128 and heavy intermediate stream 130. Separation of the effluent stream can occur in the catalytic cracking unit or a separate separation unit (not shown) in fluid communication with catalytic cracking unit. Such separation units are known in the art. Heat recovered from the cooling process can be provided to catalytic cracking unit 106. Light intermediate stream 128 can include C5− hydrocarbons (e.g., C2 to C4 olefins and saturated hydrocarbons) and heavy intermediate stream 130 can include C5+ hydrocarbons (e.g., aromatics). Heavy intermediate stream 130 can be further processed to produce aromatics and other valuable products.

Light intermediate stream 128 can exit catalytic cracking unit 106 and enter steam cracking unit 110. In some embodiments a portion (e.g., C2, C3, C4 olefins) can be separated from light intermediate stream to produce olefins product stream 136. In steam cracking unit 110 light intermediate stream 128 can be subjected to conditions to produce smaller molecular weight hydrocarbons (e.g., methane, ethylene, propylene, butenes, etc.). By way of example, at least a portion of the light intermediate stream 128 can be diluted with steam and heated in a furnace without the presence of oxygen under conditions suitable to crack the C2 to C4 hydrocarbons. Steam cracking conditions can include temperature, pressure, weight hourly space velocity, residence time or a combination thereof. The steam cracking temperature can range from 700° C. to 1000° C., 800° C. to 950° C. or any value or range there between (e.g., 700° C., 750° C., 800° C., 850° C., 900° C., 950° C., and 1000° C.). A steam cracking pressure can be 0.5 MPa to 5 MPa, or 0.5 MPa, 1 MPa, 1.5 MPa. 2 MPa. 2.5 MPa, 3 MPa, 3.5 MPa. 4MPa, 4.5 MPa or 5 MPs or any value or range there between. The residence time can be 100 to 5000 milliseconds (ms). Product stream 132 can exit steam cracking unit 110 and be further processed, stored, transported or a combination thereof. Product stream 132 can be a mixture of olefins (e.g., ethylene, propylene, butene, and/or butadiene) and C5+ hydrocarbons (e.g., pentane, pentene, hexane, heptane, octane, benzene, xylene, and/or toluene and the like). Any methane produced can be separated from product stream 132 using conventional methods and be used a fuel for catalytic cracking unit 108.

In some embodiments, separation unit 104 produces a third fraction in addition to first fraction 116 and second fraction 118. The third fraction can have a boiling temperature of less than 30° C. Referring to FIG. 3, processing of the three fractions (e.g., first fraction 116, second fraction 118 and third fraction 300) using system 100 described in FIGS. 1 and 2. First fraction 116 can have a boiling range of 35° C. to 295° C. second fraction can have a boiling range of 300° C. to 600° C., and third fraction 300 can have a boiling range of 10° C. to 30° C. Third fraction 300 can exit separation unit 104 and enter steam cracking unit 110, be combined with light intermediate stream 128, or a combination thereof. First fraction 116 and second fraction 118 can be processed as described in FIG. 1.

### B. Hydrocarbon Feed

The hydrocarbon feed can be tight oil, mixed wasted plastic oil, or a combination thereof. The tight oil can be any produced tight oil. Tight oil can have a density of 0.7 Kg/m³ to 0.9 Kg/m³ at 20° C., preferably 0.8 Kg/m³ at 20° C. and boiling temperature range of 20° C. to 500° C., preferably 50° C. to 450° C. or any value or range there between. The tight oil can include 0.5 wt. % to 5 wt. % LPG, 30 wt. % to 45 wt. % of naphtha, 10 to 20 wt. % kerosene, 20 to 30 wt. % diesel, 15 wt. % to 30 wt. % of atmospheric residue, 10 wt. % to 25 wt. % vacuum gas oil, 1 wt. % to 10 wt. % vacuum residue. Tight oil can include one or metal or metal compounds. Non-limiting examples include iron, sodium, potassium, barium, calcium, magnesium and the like. An iron content can be 2 ppm to 10 ppm by weight or any range or value there between (e.g., 2 ppm, 3 ppm, 4 ppm, 5 ppm, 6 ppm, 7 ppm. 8 ppm, 9 ppm, and 10 ppm) based on the total weight of the tight oil. A sodium content can be 5 ppm to 15 ppm by weight or any range or value there between (e.g., 5 ppm, 6 ppm, 7 ppm, 8 ppm, 9 ppm, 10 ppm, 11 ppm, 12 ppm, 13 ppm, 14 ppm and 15 ppm) based on the total weight of the tight oil. A potassium content can be less than 0.04 ppm to 0.5 ppm by weight or any range or value there between (e.g., 0.01 ppm, 0.05 ppm, 0.1 ppm. 0.15 ppm. 0.2 ppm. 0.25 ppm, 0.3 ppm, 0.35 ppm, 0.4 ppm, 0.45 ppm and 0.5 ppm) based on the total weight of the tight oil. A calcium content can be 0.1 ppm to 10 ppm by weight or any range or value there between (e.g., 0.1 ppm, 0.5 ppm, 1 ppm, 2 ppm, 3 ppm, 4 ppm, 5 ppm, 6 ppm, 7 ppm, 8 ppm, 9 ppm and 10 ppm) based on the total weight of the tight oil. A magnesium content can be 0.1 ppm to 0.5 ppm by weight or any range or value there between (e.g., 0.1 ppm, 0.15 ppm, 0.2 ppm, 0.25 ppm, 0.3 ppm, 0.35 ppm, 0.4 ppm, 0.45 ppm and 0.5 ppm) based on the total weight of the tight oil.

The mixed waste plastic oil can be any commercially or manufactured mixed waste plastic oil Non-limiting properties of the mixed waste plastic oil can include a density of 800 Kg/m³ to 815 Kg/m³ at 20° C. preferably 813 Kg/m³ at 20° C., and boiling temperature range of 80° C. to 600° C., preferably 80° C. to 450° C. or any value or range there between. A chemical composition of the mixed waste plastic oil can include paraffins, iso-paraffins, olefins, naphthenes, aromatics, total nitrogen, total sulfur, total oxygen, and total chlorine and the like. A paraffins content can be 15 to 20 wt. % or any value or range there between (e.g., 15 wt. %, 16 wt. % 17 wt. %, 18 wt. %, 19 wt. %, and 20 wt. %) based on the total weight of the mixed waste plastic oil. An iso-paraffins content can be 13 to 18 wt. % or any value or range there between (e.g., 13 wt. %, 14 wt. %, 15 wt. %, 16 wt. % 17 wt. %, and 18 wt. %, based on the total weight of the mixed waste plastic oil. A total olefins content can be 20 wt. % to 30 wt. % or any range or value there between (e.g., 20 wt. %, 21 wt. % 22 wt. %, 23 wt. %, 24 wt. %, 25 wt. %, 26 wt. %, 27 wt. %, 28 wt. %, 29 wt. % and 30 wt. %) based on the total weight of the mixed waste plastic oil. A total naphthenes content can be 30 to 35 wt. % or any value or range there between (e.g., 30 wt. %, 31 wt. % 32 wt. %, 33 wt. %, 34 wt. %, and 35 wt. %) based on the total weight of the mixed waste plastic oil. A total aromatics content can be 5 wt. % to 10 wt. % or any value or range there between (e.g., 5 wt. %, 6 wt. % 7 wt. %, 8 wt. %, 9 wt. %, 10 wt. %) based on the total weight of the mixed waste plastic oil. A total nitrogen content can be 3100 parts per million (ppm) to 3400 ppm by weight or any range or value there between (e.g., 3100 ppm, 3150 ppm, 3200 ppm, 3250 ppm, 3300 ppm. 3350 ppm, 3400 ppm) based on the total weight of the mixed waste plastic oil. A total sulfur content can be 120 to 150 ppm by weight or any range or value there between (e.g., 120 ppm, 125 ppm, 130 ppm, 135 ppm, 140 ppm, 145 ppm, 150 ppm) based on the total weight of the mixed waste plastic oil. A total oxygen content can be 11500 to 11800 by weight or any range or value there between (e.g., 11500 ppm, 11550 ppm, 11600 ppm, 11650 ppm, 11700 ppm, 11750 ppm, 11800 ppm) based on the total weight of the mixed waste plastic oil. A total chloride content can be 1800 to 2000 ppm by weight or any range or value there between (e.g., 1800 ppm, 1850 ppm, 1900 ppm, 1950 ppm, 2000 ppm,) based on the total weight of the mixed waste plastic oil.

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein can be utilized. Accordingly, the appended claims are intended to include within their scope such processes, machines, manufacture, compositions of matter, means, methods, or steps.

1. A process to produce light olefins and aromatics, the process comprising:
(a) hydrotreating a hydrocarbon feed comprising tight oil, mixed waste plastic oil, or a mixture thereof to produce a hydrotreated hydrocarbon feed;
(b) separating the hydrotreated hydrocarbon feed of step (a) into a first fraction having a boiling temperature of less than 300° C. and a second fraction having a boiling temperature of 300° C. or more;
(c) converting the first fraction into light olefins and aromatics; and
(d) converting the second fraction into aromatics.

2. The process of claim 1, wherein:
converting the first fraction into light olefins and aromatics comprises catalytically cracking the first fraction, the intermediate hydrocarbon fraction, or a blend thereof under conditions sufficient to produce a products stream comprising aromatics and a gaseous hydrocarbons comprising C5− hydrocarbons; and
converting the second fraction into aromatics comprises catalytically reforming the second fraction under conditions sufficient to produce aromatics and an intermediate hydrocarbon fraction.

3. The process of claim 2, further comprising steam cracking the gaseous hydrocarbons under conditions sufficient to produce light olefins and aromatics.

4. The process of claim 1, wherein separating the hydrotreated hydrocarbon feed of step (a) further produces a third fraction having a boiling temperature less than 30° C., and the process further comprises steam cracking the third fraction, the gaseous hydrocarbons, or a blend thereof under conditions sufficient to produce light olefins.

5. The process of claim 1, further comprising treating the hydrocarbon feed prior to step (a) hydrotreating under conditions sufficient to remove one or more metals.

6. The process of claim 1, wherein the hydrocarbon feed comprises naphtha.

7. The process of claim 1, further comprising blending naphtha with the first fraction having a boiling temperature of less than 300° C. feed.

8. The process of claim 2, wherein catalytic cracking conditions comprise a temperature of 500 to 750° C., a pressure of 0.1 to 0.5 MPa, or a combination thereof.

9. The process of claim 8, wherein the steam cracking conditions comprise a temperature of 700 to 1000° C., a pressure of 0.01 MPa to 0.2 MPa, or a combination thereof.

10. The process of claim 9, wherein catalytic reforming conditions comprise a temperature of 400 to 600° C., a reaction pressure of 0.5 MPa to 5 MPa, or a combination thereof.

11. The process of claim 1, wherein the hydrotreating reaction conditions comprise a temperature of 300° C. to 600° C., a pressure of 2 MPa to 15 MPa, or a combination thereof.

12. The process of claim 1, wherein the light olefins comprise ethylene and the aromatics comprise benzene, toluene, or xylene, or any combination thereof.

13. The process of claim 1, wherein step (d) produces a C9+ or a heavy fuel oil fraction, and the fraction is optionally hydrotreated or catalytically cracked based on the paraffin content of the fraction.

14. The process of claim 1, wherein step (d) produces a C9+ or a heavy fuel oil fraction, and the fraction is optionally used to supply heat to the catalytic cracking unit.

15. A system for producing light olefins and aromatics using the processes of claim 1, the system comprising:
a hydrotreater capable of hydrotreating a hydrocarbon feed comprising tight oil, mixed plastic oil, or a blend thereof to produce a hydrotreated hydrocarbon feed;
a separator coupled to the hydrotreater, the separator capable of separating the hydrotreated hydrocarbon feed into a first fraction having a boiling temperature of less than 300° C., a second fraction having a boiling temperature of 300° C. or more, and an optional third fraction having a boiling temperature of less than 30° C.;
a catalytic reformer coupled to the separator, the catalytic reformer capable of reforming the second fraction into aromatics and an intermediate hydrocarbon feed;
a catalytic cracker coupled to the catalytic reformer, the catalytic cracker capable of catalytically cracking the first fraction, the intermediate hydrocarbon feed, or a mixture thereof, into aromatics and a gaseous hydrocarbon feed comprising C1 to C5− hydrocarbons; and
a steam cracker coupled to the catalytic cracker, the steam cracker capable of steam cracking the gaseous hydrocarbon feed, the optional third fraction having a boiling temperature of less than 30° C., or a mixture thereof, to produce light olefins and aromatics.
